(19) United States
(12) Patent Application Publication
(10) Pub. No.: US 2017/0144132 A1
(43) Pub. Date: May 25, 2017

(54) FILTERS COMPRISING AN ACTIVATED CARBON PARTICLE COATED WITH PDADMAC AND METHODS OF MAKING SAME

(71) Applicant: Helen of Troy Limited, St. Michael (BB)

(72) Inventors: Andrew Thomas Pearks, Cincinnati, OH (US); Aloysius Ike Ononye, Loveland, OH (US); Michael Donovan Mitchell, Cincinnati, OH (US); Dimitris Ioannis Collias, Mason, OH (US); David William Bjorkquist, Olympia, WA (US); Peter William Beerse, Morrow, OH (US)

(21) Appl. No.: 15/424,443

(22) Filed: Feb. 3, 2017

Related U.S. Application Data
(63) Continuation of application No. 12/963,720, filed on Dec. 9, 2010, now abandoned.
(60) Provisional application No. 61/286,180, filed on Dec. 14, 2009.

(51) Int. Cl. B01J 20/32; B01J 20/30; B01J 20/26; B01J 20/28; C02F 1/28; B01J 20/20

(52) U.S. Cl. CPC B01J 20/3204; C02F 1/288; C02F 1/283; C02F 1/285; B01J 20/20; B01J 20/261; B01J 20/2803; B01J 20/3028; B01J 20/3276

(57) ABSTRACT

Embodiments of systems and methods for producing a coated activated carbon comprise the steps of providing activated carbon particles having a particle size up to about 100 μm, and coating the activated carbon particles by spraying droplets of a cationic polymer solution onto the surface of the activated carbon particles, wherein the cationic polymer solution comprises about 1% to about 15% by weight cationic polymer and the droplet size is between about 5 μm to about 100 μm.

### CROSS-REFERENCE TO RELATED APPLICATIONS

The present application claims the benefit of priority to U.S. Provisional Application Ser. No. 61/286,180, filed Dec. 14, 2009, the entire contents of which are hereby incorporated by reference.

### TECHNICAL FIELD

The present invention is generally directed to water filters and methods of producing potable water, and is specifically directed to water filters comprising activated carbon with a polymeric coating and methods of making same.

### BACKGROUND

Fluid contaminants, particularly contaminants in water, may include various elements and compositions such as heavy metals (e.g., lead), microorganisms (e.g., bacteria, viruses), acids (e.g., humic acids), or any contaminants listed in NSF/ANSI Standard No. 53. As used herein, the terms “microorganism”, “microbiological organisms”, “microbial agent”, and “pathogen” are used interchangeably. These terms, as used herein, refer to various types of microorganisms that can be characterized as bacteria, viruses, parasites, protozoa, and germs. In a variety of circumstances, these contaminants, as set forth above, must be removed before the water can be used. For example, in many medical applications and in the manufacture of certain electronic components, extremely pure water is required. As a more common example, any harmful contaminants must be removed from the water before it is potable, i.e., fit to consume. While filtering is conducted in some industrial/municipal water treatment systems, these filters may not be suitable for and/or achieve the removal performance suitable or required for use in consumer-friendly water filtering applications, e.g. household and personal use filter applications, and/or to produce potable water. As a result, there is a continual need for filters with improved removal capability of contaminants.

### SUMMARY

According to one embodiment, a method for producing a coated activated carbon is provided. The method comprises the steps of providing activated carbon particles having a particle size up to about 100 μm, and coating the activated carbon particles by spraying droplets of a cationic polymer solution onto the surface of the activated carbon particles, wherein the cationic polymer solution comprises about 1 to about 15% by weight cationic polymer and the droplet size is between about 5 μm to about 100 μm.

These and additional objects and advantages provided by the embodiments of the present invention will be more fully understood in view of the following detailed description, in conjunction with the drawings.

### BRIEF DESCRIPTION OF THE DRAWINGS

The following detailed description of specific embodiments of the present invention can be best understood when read in conjunction with the drawings enclosed herewith.

FIGS. 1A and 1B are Secondary Ion Mass Spectrometry (SIMS) micrographs depicting the location of carbon particle ions and cationic polymer ions, respectively, when spray coating a 12% by weight pDADMAC solution having a 80-120 μm droplet size on the activated carbon;

FIGS. 2A and 2B are SIMS micrographs depicting the location of carbon particle ions and cationic polymer ions, respectively, when spray coating a 4% by weight pDADMAC solution having a 20 μm droplet size on the activated carbon according to one or more embodiments of the present invention; and

FIG. 3 is a flow chart depicting a method of producing cationic coated activated carbon particles according to one or more embodiments of the present invention.

The embodiments set forth in the drawings are illustrative in nature and not intended to be limiting of the claimed invention. Moreover, individual features of the drawings and invention will be more fully apparent and understood in view of the detailed description.

### DETAILED DESCRIPTION

Embodiments of the present disclosure are directed to improved activated carbon filters comprising activated carbon particles with cationic polymer coatings thereon, and methods of making these coated activated carbon particles. Specifically, the embodiments of the present disclosure are directed to applying cationic polymer coatings in a manner which reduces elution. As used herein, “elution” means washing away at least a portion of the cationic polymer coating on the activated carbon particles upon the introduction of water. As the production of purified potable water is desirable, elution of cationic polymer into the water being filtered is undesirable. Consequently, the present methods optimize the coating homogeneity and quantity to minimize elution while maintaining microbial removal performance.

The activated carbon filters, which are described in detail below, are operable individually to remove contaminants such as heavy metals, humic acids, and/or microorganisms from fluids, or may be used in tandem to remove such contaminants more effectively and/or at an increased level. For example, the present filters are able to satisfy the EPA guide standard for microbiological purifiers, which recommend a 6 log bacteria RT reduction with a 4 log MS2 bacteriophage reduction. The water filters may be used in industrial and commercial applications as well as personal consumer applications, e.g., household and personal use applications. The water filter is operable to be used with various fixtures, appliances, or components familiar to one of skill in the art.

The carbon filters may comprise activated carbon particles, and may include various suitable compositions and structures. In one embodiment, the carbon filter may be a filter block containing activated carbon particles or powders compressed into a block structure. As used herein, the phrase “filter block” is intended to refer to a mixture of filter particles bound together to form a structure that is capable of filtering a liquid, for example water, air, hydrocarbons, and the like. As such a filter block may comprise filter particles, binder particles, and other particles or fibers for the removal of specific contaminants, such as lead, mercury, arsenic, etc. A filter block can vary in geometry and flow patterns. One of many contemplated current filter block making processes is a single cavity compression molding process using ohmic heating.

Alternatively, the carbon filter may comprise of loose bed of carbon particles with or without a binder. In another embodiment, the activated carbon particles may be impregnated into any substrate media familiar to one of ordinary skill in the art, for example, nonwoven substrates. Moreover, the filters of the present invention may also comprise other filter systems including reverse osmosis systems, ultra-violet light systems, ozone systems, ion exchange systems, electrolyzed water systems, and other water treatment systems known to those of ordinary skill in the art. Also, the filters of the present invention may comprise pre-filters wrapped around the filter blocks to prevent the filter blocks from clogging with suspended particles. Furthermore, the filters of the present invention may comprise indicator systems and/or shut-off systems to indicate to the consumer the remaining life/capacity of the filter and to shut-off the filter when the filter's remaining life/capacity is zero.

In accordance with a few exemplary embodiments, the activated carbon particles of the carbon filter may comprise carbons from a variety of sources, e.g., wood-based carbon, coconut carbon, or combinations thereof. Other sources, for example, suitable lignocellulose derived carbons, are contemplated herein. In some embodiments, it may be desirable to use mixtures of carbon particles to achieve a desired particle and pore size distribution. For example, wood based carbons, which are predominantly mesoporous (between 2 and 50 nm pore size) and coconut carbons, which are predominantly microporous (less than 2 nm pore size), may be mixed together. Examples of such activated carbon particle structures and compositions are provided in U.S. Pat. Nos. 7,316,323, 6,852,224, 6,827,854, 6,783,713, 6,733,827, 6,565,749, 6,423,224, 6,290,848, and U.S. Publication Nos. 20080015611, 20070080103, 20040159596, 20040232065, 20040129617, and 20040164018, which are all incorporated by reference in their entirety herein.

As used herein, the phrase “median particle size” refers to the diameter of a particle below or above which 50% of the total volume of particles lies. This median particle size is designated as D_{v,0.50}. While many methods and machines are known to those skilled in the art for fractionating particles into discreet sizes, sieving is one of the easiest, least expensive and common ways to measure particle sizes and particle size distributions. An alternative preferred method for determining size distribution of particles is with light scattering. Further, the phrase, “particle span” is a statistical representation of a given particle sample and can be calculated as follows. First, the median particle size, D_{v,0.50}, is calculated as described above. Then by a similar method, the particle size that separates the particle sample at the 10% by weight fraction, D_{v,0.10}, is determined, and then the particle size that separates the particle sample at the 90% by volume fraction, D_{v,0.90}, is determined. The particle span is then equal to: (D_{v,0.90}−D_{v,0.10})/D_{v,0.50}. In one exemplary embodiment, the carbon filter may comprise activated carbon filter particles having a median particle size of less than about 100 μm, less than about 50 μm, less than about 40 μm, less than about 37.5 μm, or less than about 35 μm. Moreover, the filter particles may have a particle span from about 1.8 or less, about 1.5 or less, about 1.4 or less, and about 1.3 or less.

Additionally, the activated carbon may demonstrate a mesopore volume from about 0.5 ml/gm to about 0.7 ml/gm, and a total pore volume from about 1 ml/gm to about 1.5 ml/gm. Moreover, in one exemplary embodiment, the activated carbon may include mesopores having a pore diameter from about 2 nm to about 50 nm, a particle size of about 30 μm diameter, and a span from about 1 to about 1.6, or from about 1.3 to about 1.4. As used herein, the term “mesopore” is intended to refer to an intra-particle pore having a width or diameter between 2 nm and 50 nm (or equivalently, between 20 Å and 500 Å). As used herein, the phrase “mesopore volume” refers to the volume of all mesopores.

In accordance with one or more embodiments, the activated carbon particles may be coated with a cationic polymer. Exemplary cationic polymers for use in the present invention are selected from the group consisting of: poly(N-methylvinylamine), polyallylamine, polyallyldimethylamine, polydiallylmethylamine, polydiallyldimethylammonium chloride (pDADMAC), polydiallyldimethylammonium trifluoromethanesulfonate (pDADMAT), polydiallyldimethylammonium nitrate (pDADMAN), polydiallyldimethylammonium perchlorate (pDADMAP), polyvinylpyridinium chloride, poly(2-vinylpyridine), poly(4-vinylpyridine), polyvinylimidazole, poly(4-aminomethylstyrene), poly(4-aminostyrene), polyvinyl(acrylamide-co-dimethylaminopropylacrylamide), polyvinyl(acrylamide-co-dimethyaminoethylmethacrylate), polyethyleneimine, polylysine, DAB-Am and PAMAM dendrimers, polyaminoamides, polyhexamethylenebiguandide, polydimethylamine-epichlorohydrine, aminopropyltriethoxysilane, N-(2-aminoethyl)-3-aminopropyltrimethoxysilane, N-trimethoxysilylpropyl-N,N,N-trimethylammonium chloride, bis(trimethoxysilylpropyl)amine, chitosan, grafted starch, the product of alkylation of polyethyleneimine by methylchloride, the product of alkylation of polyaminoamides with epichlorohydrine, cationic polyacrylamide with cationic monomers, dimethyl aminoethyl acrylate methyl chloride (AETAC), dimethyl aminoethyl methacrylate methyl chloride (METAC), acrylamidopropyl trimethyl ammonium chloride (APTAC), methacryl amodopropyl trimethyl ammonium chloride (MAPTAC), diallyl dimethyl ammonium chloride (DADMAC), ionenes, silanes and mixtures thereof. Preferably the cationic polymers are selected from the group consisting of: polyaminoamides, polyethyleneimine, polyvinylamine, polydiallyldimethylammonium chloride (pDADMAC), polydimethylamine-epichlorohydrin, polyhexamethylenebiguanide, poly-[2-(2-ethoxy)-ethoxyethlyl-guanidinium]chloride.

While many cationic polymers are contemplated for use in the coating, the cationic polymer may, in one embodiment, comprise polydiallydimethylammonium chloride (pDADMAC) alone or in combination with one or more cationic polymers. The cationic polymer solution may comprise about 1% to about 15% by weight cationic polymer, or about 2% to about 8% by weight cationic polymer, or specifically about 2% by weight cationic polymer. After drying, the pDADMAC may comprise from about 1% to about 4% by weight, or about 2% by weight, of the pDADMAC coated carbon. Additionally, it has also been discovered that the molecular weights for the pDADMAC polymer, which are dependent in part on the degree of polymerization of the DADMAC, impacts the efficacy of the pDADMAC coating. For example, it has been found that a pDADMAC polymer with a weight average molecular weight (Mw) up to about 200,000 g/mol and a number average molecular weight (Mn) of up to about 100,000 g/mol is superior to a pDADMAC polymer with a Mw from about 300,000 g/mol to about 500,000 g/mol of the polymer and a Mn of from about 150,000 g/mol to about 300,000 g/mol. With a larger polymer chain, there is more likelihood of overcoating of pDADMAC on the carbon particle surface, which may result in elution.

Additionally, the carbon filters may include organic binders, inorganic binders, or combinations thereof. One example of a suitable binder is a polyethylene binder. Moreover, although the carbon block filter is effective for removal of all types of fluid contaminants, it may be desirable to utilize an additional heavy metal removal composition. For, example, amorphous titanium silicate (ATS) is highly effective as a lead adsorbent. Other suitable heavy metal removal components are contemplated herein. It is also contemplated to use additional components, such as ion exchange resins, additional sorbents, or combinations thereof.

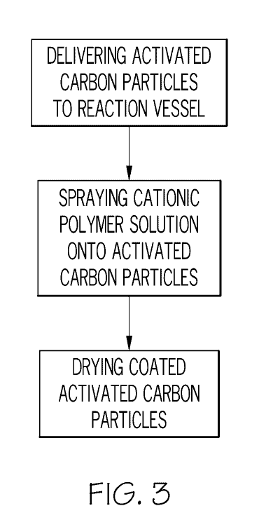

Further embodiments, for example, as shown in FIG. 3, are directed to improved methods for applying the cationic coating to the activated carbon particles. As stated above, the activated carbon particles may comprise various sizes depending on the contaminants sought to be removed. In one embodiment, the activated carbon particles comprise an average particle size up to about 100 μm, or between 20 μm to 80 μm, or between about 30 μm to 40 μm. As used herein, “average particle size”, refers to the mean or average diameter for the total volume of particles. The activated carbon particles may be coated by spraying droplets of a cationic polymer solution onto the surface of the activated carbon particles. The droplets may comprise a size of between about 5 μm to about 100 μm, or about 15 μm to about 55 μm, or about 20 μm to about 30 μm. By reducing the droplet size, the cationic coating is distributed more uniformly and homogeneously on the activated carbon particles, which thereby minimizes elution of the cationic polymer.

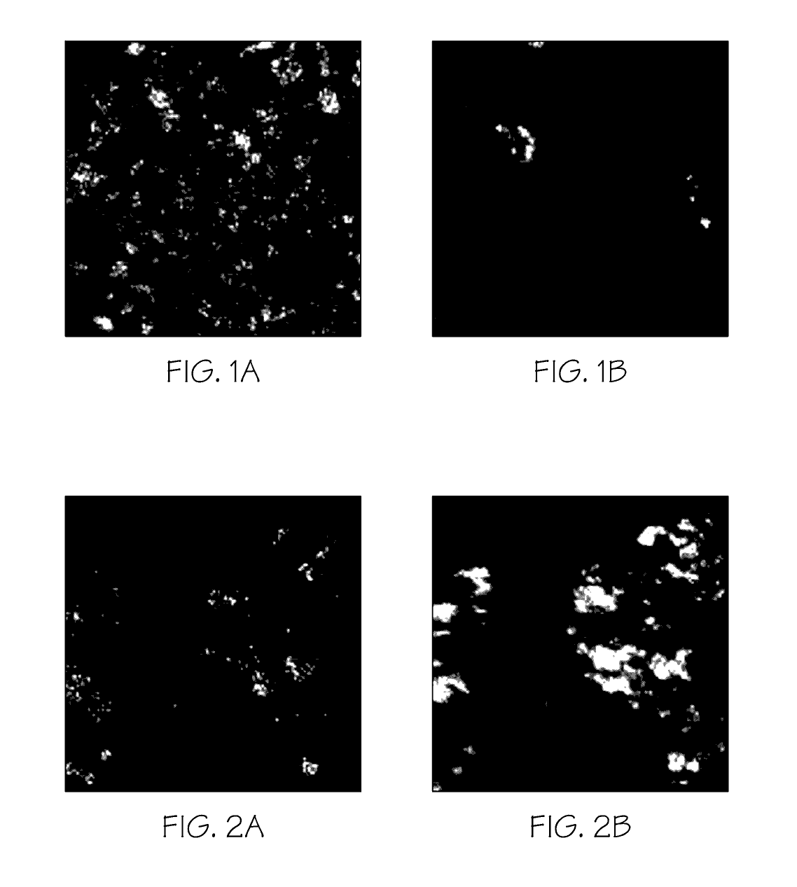

FIGS. 1A-2B show comparative secondary ion mass spectrometry (SIMS) images of coated activated carbon particles. For FIGS. 1A-1B and 2A-2B, the activated carbon particles comprise median particle sizes of 36 and 35 microns, respectively. FIGS. 1A-2B show coated activated carbon particles produced by spraying a 12% by weight pDADMAC solution via 80-120 μm droplets (FIGS. 1A and 1B) and images of coated activated carbon particles produced by spraying 4% by weight pDADMAC solution via 20 μm droplets (FIGS. 2A and 2B) in accordance with one or more embodiments of the present invention. Referring to FIG. 1A and 1B, the image on the left is a map of C₂ ions specific to coated carbon particles, and the image on the right is a map of chloride ions specific to the polymer. As shown in FIGS. 1A-1B, the field of carbon particles (FIG. 1A) demonstrates very little correspondence with the polymer field (FIG. 1B), which demonstrates presence of polymer. In contrast, FIGS. 2A and 2B show a close match between locations of carbon (FIG. 2A) and polymer (FIG. 2B). Both sets of images reveal a 500×500 μm field of view and are representative of several different images taken of both samples of coated carbon. The cationic polymer solution may comprise any suitable solvent familiar to one of ordinary skill in the art, for example, water, an alkyl alcohol, or combinations thereof. By diluting the amount of cationic polymer in the cationic polymer solution, polymer mobility is increased and it gives the polymer chains room to stretch out, therefore strengthening the mechanism of binding between cationic polymer and activated carbon particle. Dilution also increases spray time, providing a longer residence time in the mixer, thereby maximizing attachments of the cationic polymer. By maximizing the attachments of cationic polymer, the elution of the cationic polymer was diminished.

Various devices and reaction mechanisms are contemplated for the spray coating of the cationic polymer. For example, the carbon particles may be placed in any suitable reaction vessel, for example, a plow mixer, a stationary or moving bed reactor, a fluidized bed reactor, etc. To deliver the cationic polymer, the reaction vessel must be coupled to or in communication with a spray coating device. For example, the reaction vessel may comprise a nozzle port, which allows spray delivery of the cationic coating into the reaction vessel. The spraying time may range from about 30 seconds up to several hours depending on the amount of cationic polymer solution delivered and the amount of coating desired on the activated carbon particles. One suitable commercial embodiment is the Littleford FM-130 plow mixer with a nozzle port. While many spray coating systems suitable for coupling to the nozzle port of the reaction vessel, one suitable commercial device is the SUN13 two-fluid nozzle produced by Spraying Systems. Other suitable commercial devices include the SUE 15 and SUE 25 commercial nozzles produced by Spraying Systems. The SUN 13 is an internal mixing nozzle wherein the cationic coating solution and the air, which shears the liquid solution to produce droplets, are mixed inside the spray nozzle. The SUE 15 and SUE 25 commercial nozzles are external mixing nozzles wherein the air and cationic solution mix after exiting the nozzle. The coating step may be conducted at an air pressure at the nozzle of about 60 psi to about 90 psi. Additionally, the coating step may be conducted with a liquid pressure at the nozzle of about 20 psi to about 90 psi. The pressure within the reaction vessel is at or close to 1 atmosphere. In fact, the vessel may be vented during spray delivery to avoid pressurization.

After coating, the coated activated carbon particles may be dried. In one embodiment, the coated activated carbon particles may be dried in the same reaction vessel used for coating. For example, the plow mixer may be jacketed such that it is suitable for vacuum-drying. An atmospheric or non-vacuum oven, a ring dryer, or other suitable embodiments are also contemplated herein. Various drying temperatures and drying times are contemplated herein. For example, the drying may occur at a temperature sufficient to yield a product temperature of between about 50° C. to about 150° C., or 70° C. to about 100° C., or about 80° C. Drying times may vary, for example, from about 30 minutes to about 4 hours, or up to about 3 hours. In one exemplary embodiment, the drying may be conducted at a temperature of about 80° C. for a time of about 3 hours or less. As discovered by the present inventors, if drying times and temperatures are not controlled, the temperature may cause the quaternary polymer to reduce to a tertiary state, resulting in degradation of the cationic charge with the release of a volatile byproduct, for example, methyl chloride.

As stated above, the present inventors have recognized that the stability of pDADMAC is at least partially temperature dependent. The adsorption of pDADMAC on granulated carbon yields a cationic polyelectrolyte on a predominantly hydrophobic surface, which may constitute an unstable state, especially at higher temperatures. As a result, pDADMAC may rearrange to eliminate the charge, thereby reducing from a quaternary polymer to a tertiary polymer and forming byproducts, such as methyl chloride. As discovered by the present inventors, replacing the chloride ion of the pDADMAC with a non-nucleophilic counterion may preclude this rearrangement, and thereby increase the temperature stability of the cationic coating. While various counterions are contemplated herein, e.g., nitrate, and perchlorate, the counterion may, in one exemplary embodiment, include trifluoromethanesulfonate instead of chloride. The pDADMAT is less likely to be reduced from the quaternary state at high temperatures.

To test the relationship between temperature and charge stability, experiments were conducted to measure the charge on the carbon due to adsorbed pDADMAC via Inverse Ion-Exchange HPLC-UV. The carbon particles are packed in a small cartridge and connected as a column to a regular high pressure liquid chromatography (HPLC) column. The chloride counter ion of the quarternary nitrogen in pDADMAC is displaced by bromide which in turn is displaced by sulfate and analyzed versus standard bromide. The charge contributed by the pDADMAC may then be calculated using the charge equivalent % metric described below.

The Charge Equiv. % for pDADMAC is as follows

$$Charge Equiv . \% pDADMAC = \frac{Sample Charge Response \text{/} mg}{Std RF per mg} \times \% Std pDADMAC$$

wherein the standard response factor (Std RF) from all standard injections is

$$Std RF \text{/} mg = \frac{UV Peak Area Response}{40} \\ ( The bromide standard is based on 40 mg equivalent coated carbon ) .$$

The sample charge response is

$$Sample Charge Response \text{/} mg = \frac{UV Peak Area Response}{Sample Wt . ( mg )}$$

The value of the “% Std pDADMAC” is either “2” or “0.5”, depending on whether one is analyzing a coated carbon powder or a filter containing coated carbon, respectively.

In two experimental examples as shown in Table 1 below, carbon samples coated with pDADMAC were subjected in duplicate to 80° C., 120° C., and 160° C. for 3 hour under vacuum. The carbon was coated at a target 2 wt % level with the actual sample measuring at about 1.8 wt %. The samples were then analyzed for charge by Inverse IE-HPLC versus standard bromide. The resulting charge was calculated as % charge equivalent pDADMAC as shown above. As shown below on Table 1, the control yielded a % charge equivalent pDADMAC of 1.81. Referring again to Table 1, no significant change was observed between 80° C. and 120° C.; however, at about 160° C., there was greater than 50% loss of charge was observed to yield values of 0.81 and 0.72 in Experiments 1 and 2, respectively.

TABLE 1

| | % Charge Equivalent |
|---|---|
| Sample | pDADMAC |
| Control | 1.81 |

Experiment 1

| | |
|---|---|
| 80° C. | 1.81 |
| 120° C. | 1.78 |
| 160° C. | 0.81 |

Experiment 2

| | |
|---|---|
| 80° C. | 1.76 |
| 120° C. | 1.76 |
| 160° C. | 0.72 |

As mentioned above, when the coated carbon is re-wetted a portion of the cationic polymer coating may elute. It was determined that elution is linked in part to coating level, since activated carbon particles that are “over-coated” (i.e., having an amount of polymer which exceeds some loading-capacity of the carbon surface) demonstrate more elution. Diluting the cationic polymer inside the cationic polymer solution and minimizing the droplet size yields improvements to elution and coating homogeneity. For example, the above described methods of applying the cationic coating minimizes elution of cationic polymer by at least 60%, and in further embodiments minimizes elution of cationic polymer by at least 90%, as compared to other conventional coating methods.

### EXAMPLES

The experimental process described below targets a 2.0 wt % coating of a FL4440 (pDADMAC) solution on the RGC granular activated carbon, assuming a polymer solids concentration of about 36% in the raw FL4440 (pDADMAC) solution.

TABLE 2

| Target | Mass of FL4440 | Mass of Water | |
|---|---|---|---|
| Wt % Coating | (kg) | (kg) | Mass of RGC (kg) |
| 1.0 | 0.55 | 19.45 | 20.00 |
| 1.5 | 0.84 | 19.16 | 20.00 |
| 2.5 | 1.39 | 18.61 | 20.00 |
| 3.0 | 1.67 | 18.33 | 20.00 |

The raw materials were added into separate vessels: 18.9 kg of USP water and 1.1 kg of Floquat FL4440 were added into a mix tank, and 20.0 kg of RGC granular activated carbon was added into a Littleford FM-130D plow mixer. The polymer solution is mixed for 5 minutes and then pressurized to 20-25 psi and then the polymer solution is delivered into a FM-130D mixer via a single SUE15 two-fluid atomization nozzle, which utilizes 60-90 psi air. Under these spraying parameters, the SUE15 nozzle will deliver the solution in 20 μm droplets. The RGC granular activated carbon is mixed at a shaft rotational speed of about 80 RPM at room temperature during this coating phase. Once delivery of the solution is complete, a vacuum is pulled on the FM-130D mixer, and pressurized steam is applied to heat the mixer jacket to a temperature of approximately 140° C., wherein the RGC continues to be mixed through a drying phase to target a product temperature of about 80° C. Once the product temperature indicates that the product is dry, the product is discharged from the mixer, and may be incorporated into a filter e.g., a filter block.

In an exemplary embodiment of producing a filter block, a mixer was filled with a powder blend consisting of 45% of the coated carbon, 36% of an activated coconut carbon from SAI Inc., 3% of an ATS lead adsorbent from Calgon Carbon, and 16% of a polyethylene binder. A portion of this mix was placed into molds and heated through resistance heating of the carbon at 8000J. The resultant block had a compression strength of 166 PSI. The resultant blocks were manufactured into water filter cartridges and tested against the EPA guide standard for microbiological purifiers. The blocks demonstrated a 7.05 log reduction of the bacteria RT and a 4.79 log reduction for the MS2 bacteriophage. In contrast, when the same experiment was conducted using 16000 kJ of energy, polymer degradation and a resultant loss in MS2 and the bacteria RT performance was noted. Specifically, the average log reduction of the Bacteria RT was 4.46, while the MS2 reduction dropped to 1.33.

It is further noted that terms like “preferably,” “generally,” “commonly,” “desirably”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for producing coated activated carbon particles comprising:
providing activated carbon particles having an average particle size of about 100 μm or less; and
coating the activated carbon particles by spraying droplets of a cationic polymer solution onto the surface of the activated carbon particles, the cationic polymer solution comprising about 1% to about 15% by weight of a cationic polymer and a droplet size of from about 5 μm to about 100 μm; and
wherein the cationic polymer comprises a polydiallydimethylammonium salt, and wherein the polydiallydimethylammonium salt comprises polydiallydimethylammonium and a non-nucleophilic counterion.

2. The method of claim 1, wherein the non-nucleophilic counterion is selected from the group consisting of nitrate, perchlorate, and trifluoromethanesulfonate.

3. The method of claim 1, wherein the non-nucleophilic counterion is trifluoromethanesulfonate.

4. The method of claim 1, wherein the cationic polymer solution further comprises polydiallydimethylammonium chloride (pDADMAC).

5. The method of claim 4, wherein the pDADMAC polymer comprises a weight average molecular weight (Mw) of up to about 200,000 g/mol and a number average molecular weight (Mn) of up to about 100,000 g/mol.

6. The method of claim 1, wherein the cationic polymer solution comprises about 2% to about 8% by weight cationic polymer.

7. The method of claim 1, wherein the cationic polymer solution comprises about 2% to about 4% by weight cationic polymer.

8. The method of claim 1, wherein the coating step is conducted at a liquid pressure of about 20 psi to about 90 psi.

9. The method of claim 1, wherein the coating step is conducted at an air pressure of about 60 psi to about 90 psi.

10. The method of claim 1, wherein the droplet size of the cationic polymer solution is between about 15 μm to about 55 μm.

11. The method of claim 1, wherein the droplet size of the cationic polymer solution is between about 20 μm to about 30 μm.

12. The method of claim 1 further comprising drying the coated activated carbon particles.

13. The method of claim 12, wherein the coated activated particles demonstrate a 6 log reduction of bacteria RT and a 4 log reduction for MS2 bacteriophage.

14. The method of claim 12, wherein the coated activated carbon particles are dried at a temperature from about 50° C. to about 150° C.

15. The method of claim 12, wherein the coated activated carbon particles are dried at a temperature from about 70° C. to about 100° C.

16. The method of claim 1, further comprising the step of compressing and heating the coated activated carbon particles to form a filter block.

17. The method of claim 15, wherein the filter block further comprises amorphous titanium silicate.

18. The method of claim 16, wherein the filter block demonstrates a 7 log reduction of bacteria RT and a 4.5 log reduction for MS2 bacteriophage.

19. A method for forming coated activated carbon for water filtration, the method comprising:
providing activated carbon particles having an average particle size of about 100 μm or less;
coating the activated carbon particles by spraying droplets of a cationic polymer solution onto the surface of the activated carbon particles, the cationic polymer solution comprising about 2% to about 4% by weight of a cationic polymer and a droplet size from about 20 μm to about 30 μm; and
drying the coated activated carbon particles at a temperature from about 70° C. to about 100° C.; and
wherein the cationic polymer comprises a polydiallydimethylammonium salt, and wherein the polydiallydimethylammonium salt comprises polydiallydimethylammonium and a non-nucleophilic counterion.

20. The method of claim 1, wherein the non-nucleophilic counterion is selected from the group consisting of nitrate, perchlorate, and trifluoromethanesulfonate.
